(19) United States
(12) Patent Application Publication
(10) Pub. No.: US 2025/0261106 A1
(43) Pub. Date: Aug. 14, 2025

(54) SSB MEASUREMENT METHOD AND APPARATUS, USER EQUIPMENT, AND STORAGE MEDIUM

(71) Applicant: VIVO MOBILE COMMUNICATION CO., LTD., Dongguan (CN)

(72) Inventors: Qi HONG, Dongguan (CN); Gen LI, Dongguan (CN); Wei JIANG, Dongguan (CN)

(73) Assignee: VIVO MOBILE COMMUNICATION CO., LTD., Dongguan (CN)

(21) Appl. No.: 19/193,953

(22) Filed: Apr. 29, 2025

Related U.S. Application Data
(63) Continuation of application No. PCT/CN2023/127778, filed on Oct. 30, 2023.

(30) Foreign Application Priority Data
Nov. 3, 2022 (CN) 202211371982.6

(51) Int. Cl. H04W 52/02; H04L 5/00; H04W 24/10

(52) U.S. Cl. CPC H04W 52/0216; H04L 5/0051; H04W 24/10; H04W 52/0235

(57) ABSTRACT

An SSB measurement method and apparatus, user equipment, and a storage medium are provided. The SSB measurement method includes: monitoring, by UE, first information sent by a power-saving base station; and performing, by the UE, SSB measurement of a power-saving cell based on the first information, where the power-saving cell is a serving cell of the power-saving base station. The first information includes at least one of the following: a first signal formed by a second signal and a payload, the first signal explicitly carries SSB index information, and the second signal includes at least one of a PSS or an SSS; a third signal formed by a PSS and an SSS, and the third signal implicitly carries SSB index information; or a fourth signal including at least one of a PSS or an SSS, and the PSS and the SSS are in different frequency domain positions.

### CROSS-REFERENCE TO RELATED APPLICATIONS

This application is a continuation of International Application No. PCT/CN2023/127778, filed Oct. 30, 2023, which claims priority to Chinese Patent Application No. 202211371982.6, filed Nov. 3, 2022. The entire contents of each of the above-referenced applications are expressly incorporated herein by reference.

### TECHNICAL FIELD

This application pertains to the field of communications technologies, and specifically relates to an SSB measurement method and apparatus, user equipment, and a storage medium.

### BACKGROUND

User Equipment (UE) in a connected state performs measurement on surrounding cells to evaluate signal quality of the cells. In this process, the protocol stipulates that the UE needs to report information such as a measured cell identifier and a Synchronization Signal Block (SSB) index to a serving cell, so as to better perform mobility management.

However, an SSB index is obtained from a Physical Broadcast Channel (PBCH) and a PBCH-demodulation reference signal (Demodulation Reference Signal, DMRS), and a base station in a power-saving mode (hereinafter referred to as a power-saving base station) does not contain a PBCH. Therefore, in this case, for the power-saving base station (not including a PBCH) that transmits a light SSB, how the UE obtains an SSB index of a cell is a problem to be urgently resolved.

### SUMMARY

Embodiments of this application provide an SSB measurement method and apparatus, user equipment, and a storage medium.

According to a first aspect, an SSB measurement method is provided, where the method includes: monitoring, by UE, first information sent by a power-saving base station; and performing, by the UE, SSB measurement of a power-saving cell based on the first information, where the power-saving cell is a serving cell of the power-saving base station. The first information includes at least one of the following:
a first signal, where the first signal is formed by a second signal and a payload, the first signal explicitly carries SSB index information, and the second signal includes at least one of the following: a Primary Synchronization Signal (PSS) or a Secondary Synchronization Signal (SSS);
a third signal, where the third signal is formed by a PSS and an SSS, and the third signal implicitly carries SSB index information; or
a fourth signal, where the fourth signal includes at least one of the following: a PSS or an SSS, and the PSS and/or the SSS are in different frequency domain positions.

According to a second aspect, an SSB measurement apparatus is provided, which is applied to UE and includes a detection module and an execution module. The detection module is configured to monitor first information sent by a power-saving base station; and the execution module is configured to perform SSB measurement of a power-saving cell based on the first information detected by the detection module, where the power-saving cell is a serving cell of the power-saving base station. The first information includes at least one of the following:
a first signal, where the first signal is formed by a second signal and a payload, the first signal explicitly carries SSB index information, and the second signal includes at least one of the following: a PSS or an SSS;
a third signal, where the third signal is formed by a PSS and an SSS, and the third signal implicitly carries SSB index information; or
a fourth signal, where the fourth signal includes at least one of the following: a PSS or an SSS, and the PSS and/or the SSS are in different frequency domain positions.

According to a third aspect, UE is provided, where the UE includes a processor and a memory, where a program or instructions capable of running on the processor are stored in the memory. When the program or the instructions are executed by the processor, the steps of the method according to the first aspect are implemented.

According to a fourth aspect, UE is provided, which includes a processor and a communication interface, where the processor is configured to monitor first information sent by a power-saving base station; and perform SSB measurement of a power-saving cell based on the first information, where the power-saving cell is a serving cell of the power-saving base station. The first information includes at least one of the following:
a first signal, where the first signal is formed by a second signal and a payload, the first signal explicitly carries SSB index information, and the second signal includes at least one of the following: a PSS or an SSS;
a third signal, where the third signal is formed by a PSS and an SSS, and the third signal implicitly carries SSB index information; or
a fourth signal, where the fourth signal includes at least one of the following: a PSS or an SSS, and the PSS and/or the SSS are in different frequency domain positions.

According to a fifth aspect, a readable storage medium is provided, where a program or instructions are stored in the readable storage medium; and when the program or the instructions are executed by a processor, the steps of the method according to the first aspect are implemented.

According to a sixth aspect, a chip is provided. The chip includes a processor and a communication interface. The communication interface is coupled to the processor, and the processor is configured to run a program or instructions to implement the method according to the first aspect.

According to a seventh aspect, a computer program/program product is provided, where the computer program/program product is stored in a storage medium, and the computer program/program product is executed by at least one processor to implement the steps of the SSB measurement method according to the first aspect.

In the embodiments of this application, the UE may monitor the first information sent by the power-saving base station to perform SSB measurement of the power-saving cell, and the first information includes at least one of the following: a first signal, where the first signal is formed by a second signal and a payload, the first signal explicitly carries SSB index information, and the second signal includes at least one of the following: a PSS or an SSS; a third signal, where the third signal is formed by a PSS and an SSS, and the third signal implicitly carries SSB index information; or a fourth signal, where the fourth signal includes at least one of the following: a PSS or an SSS, and the PSS and/or the SSS are in different frequency domain positions. In this solution, during monitoring on SSB information sent by the power-saving base station, the UE can detect the first information sent by the power-saving base station, where the first information explicitly or implicitly carries the SSB index information, that is, the UE can obtain the SSB index information from the detected first information to perform SSB measurement of the power-saving cell. Therefore, this solution implements that the UE can obtain required SSB index information in an explicit or implicit manner in a case of light SSBs, thus facilitating SSB measurement and reporting by the UE.

### BRIEF DESCRIPTION OF DRAWINGS

FIG. 1 is a schematic architectural diagram of a wireless communication system according to an embodiment of this application;

FIG. 2 is a schematic structural diagram of an SSB provided in the related art;

FIG. 3 is a schematic diagram of an example of bits contained in a PBCH provided in the related art;

FIG. 4 is a first flowchart of an SSB measurement method according to an embodiment of this application;

FIG. 5 is a schematic diagram of an example of adding a payload to a symbol of an SSB according to an embodiment of this application;

FIG. 6 is a second flowchart of an SSB measurement method according to an embodiment of this application;

FIG. 7 is a third flowchart of an SSB measurement method according to an embodiment of this application;

FIG. 8 is a schematic structural diagram of an SSB measurement apparatus according to an embodiment of this application;

FIG. 9 is a schematic diagram of a hardware structure of a communication device according to an embodiment of this application; and

FIG. 10 is a schematic diagram of a hardware structure of UE according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. Based on the embodiments in this application, all other embodiments obtained by ordinary people in this field belong to the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a Long Term Evolution (LTE) or LTE-Advanced (LTE-A) system, and may also be applied to other wireless communications systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other applications than an NR system application, for example, the 6^{th} Generation (6G) communication system.

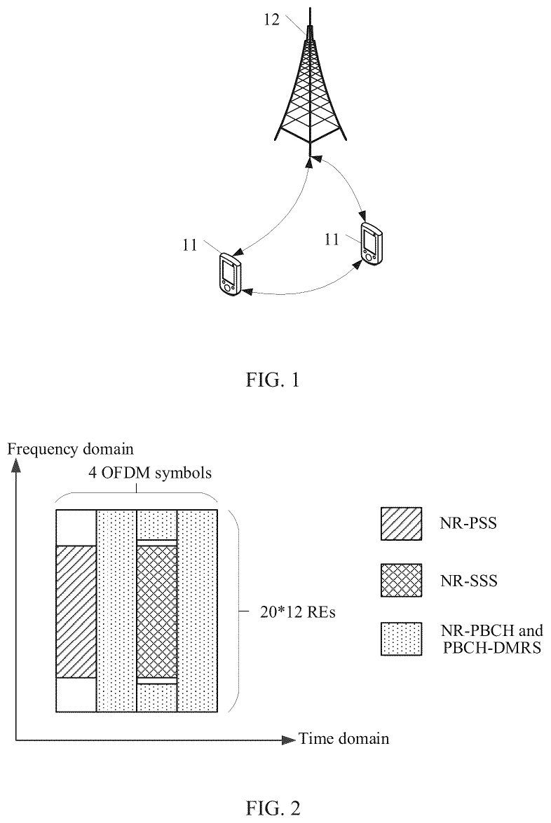

FIG. 1 illustrates a block diagram of a wireless communication system to which an embodiment of this application can be applied. The wireless communication system includes a terminal 11 and a network-side device 12. The terminal 11 may be a terminal-side device such as a mobile phone, a tablet computer and a notebook computer, a laptop computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. It should be noted that a specific type of the terminal 11 is not limited in the embodiments of this application. The network-side device 12 may include an access network device or a core network device, where the access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a transmission and reception point (Transmitting Receiving Point, TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited.

The following describes some concepts and/or terms involved in an SSB measurement method and apparatus, user equipment, and a storage medium provided in the embodiments of this application.

### 1. SSB Structure

An initial search process is completed by using an SSB. The SSB is formed by a PSS, an SSS, a PBCH, and a DMRS in four consecutive Orthogonal Frequency Division Multiplexing (OFDM) symbols, and can be used for downlink synchronization.

As shown in FIG. 2, a structure of the SSB includes a PSS (NR-PSS), an SSS (NR-SSS), a PBCH (NR-PBCH), and PBCH-DMRS. The functions of the PSS and SSS are to achieve symbol (symbol)-level synchronization and to determine the Physical Cell Identity (PCI) NG″. The PBCH contains the Master Information Block (MIB) of the cell and some additional information. The PBCH-DMRS contains part of SSB index information (the 3 least significant bits).

### 2. Synchronization Raster

When performing a cell search after power-on, the UE can only detect SSB signals based on frequency bands supported by the operator and the UE to achieve downlink time-frequency synchronization. Given the fine granularity of the global frequency raster which results in a large NR-ARFCN range, blind detection using the global frequency raster could lead to significant synchronization delays. To effectively reduce synchronization delays during this process, the concept of a synchronization raster is defined, and a search range is limited using the Global Synchronization Channel Number (GSCN). As shown in Table 1, the synchronization raster ranges are defined as follows: within 0 MHZ-3000 MHz, the synchronization raster is 1200 kHz; within 3000 MHz-24250 MHz, the synchronization raster is 1.44 MHz; and within 24250 MHz-100000 MHz, the synchronization raster is 17.28 MHz. Similar to the NR Absolute Radio Frequency Channel Number (NR-ARFCN), the GSCN also defines the frequency bands in the range of 0 GHz-100 GHz, with each GSCN corresponding to one SSB detection frequency point.

TABLE 1

| Frequency | SSB frequency domain | | GSCN |
|---|---|---|---|
| range | position SS_{REF} | GSCN | range |
| 0-3000 | N*1200 kHz + M*50 kHz, | 3N + | 2-7498 |
| MHZ | N = 1:2499, | (M − 3)/2 | |
| | M∈{1, 3, 5}(Note) | | |
| 3000-24250 | 3000 MHz + N*1.44 MHz | 7499 + N | 7499-22255 |
| MHz | N = 0:14756 | | |
| 24250-100000 | 24250.08 MHz + | 22256 + N | 22256-26639 |
| MHz | N*17.28 MHz | | |
| | N = 0:4383 | | |

It should be noted that a default value for an operating frequency band that only supports the Sub-Carrier Spacing (SCS) interval channel raster is M=3.

### 3. PBCH

Since the internal structure of the SSB is standardized by the protocol, the UE can attempt to decode the SSB once it has detected a synchronization signal at a specific frequency point. The MIB contained within the SSB is the most important information. The MIB includes:

System Frame Number (SFN): A complete frame number requires 10 bits, while the MIB payload only includes 6 most significant bits of the frame number, with 4 least significant bits transmitted in non-MIB bits of a PBCH transport block.

Sub-Carrier Spacing Common of downlink signals in the initial access process: indicates the sub-carrier spacing for SIB1/OSI/initial access Msg2/Msg4/paging messages.

SSB-sub-carrier offset (Ssb-Sub Carrier Offset): the number of sub-carrier spacings between the lowest sub-carrier of the SSB and a nearest PRB.

DMRS-Type A-Position: configuration for PDSCH DMRS reference signals.

PDCCH-ConfigSIB1: configuration of SIB1_PDCCH, including a control resource set (CORESET) and search space configuration.

Cell barred information: an RRC access control parameter, which indicates whether a cell is barred.

Intra-frequency cell reselection information (intra FreqReselection): an RRC access control parameter, which indicates whether intra-frequency reselection is allowed for the cell.

Spare: a reserved bit position.

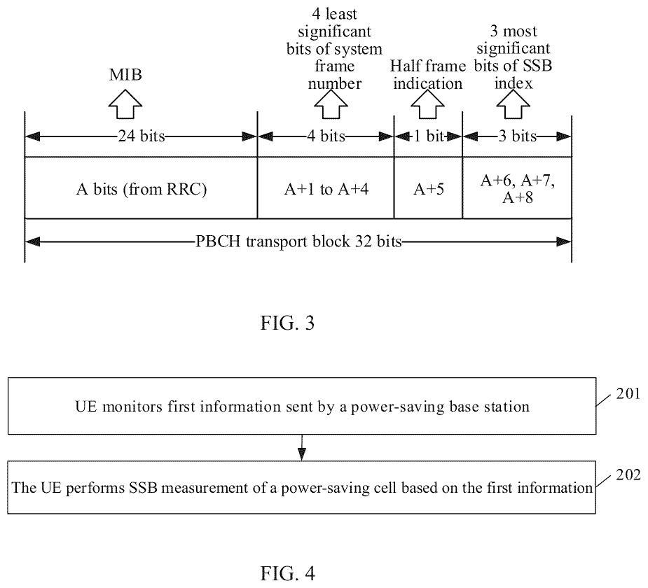

Additionally, the PBCH contains other information than the MIB information as shown in FIG. 3, and the PBCH includes the following bits:

A+1 to A+4:4-bit frame number information is added. Once the 4 least significant bits of the system frame number are obtained, combined with the 6-bit system frame number in the MIB, the entire 10-bit frame number can be obtained.

A+5: A half-frame information bit is added, where the bit indicates whether it is the front half-frame or the back half-frame.

A+6 to A+8: If the largest SSB index L is 64 (that is, F>6 GHz), A+6 to A+8 identify 3 most significant bits of the SSB index; otherwise, A+6 is 1 most significant bit of Kssb, and A+7/A+8 is a reserved bit.

### 4. Cell Search

Initial search is needed when UE powers on or during a cell handover, and is intended to obtain downlink synchronization with a cell:

(1) time synchronization detection (detecting a position of a synchronization signal, type of Cyclic Prefix (CP), a cell ID number, and the like); and

(2) frequency synchronization detection (using the PSS and SSS for frequency offset estimation and correction). In some embodiments, the primary purpose of the initial search is to locate a usable network, that is, the UE performs a blind search across complete network bands based on its supported frequency bands and protocol-defined synchronization signal block numbers (GSCN).

The UE can only detect a cell when it is within a coverage range of the cell. In addition to the cell search during power-on, in order to support mobility, the UE continually searches for cells (SSB measurement), achieving synchronization and evaluating received quality of the cell, so as to determine whether to perform a handover (handover, when the UE is in an RRC_connected state) or a cell reselection (cell re_selection, when the UE is in an RRC IDLE or RRC INACTIVE state).

The NR defines a total of 1008 different PCIs N_{ID}^{cell}. N_{ID}^{cell}=3N_{ID}⁽¹⁾+N_{ID}⁽²⁾. The PSS corresponds to N_{ID}⁽²⁾, which is three candidate m sequences carrying part of cell ID information. The SSS corresponds to Np, which is 336 candidate m sequences carrying part of cell ID information.

### 5. Cell Measurement and Reporting

In the mobile communication network, it is necessary to measure a signal strength or quality (matrix, that is, Reference Signal Received Power (RSRP) or Reference Signal Receiving Quality (RSRQ)) of the serving cell and the neighboring cell when the UE is to hand over to a cell with stronger signals and add a new carrier (CC) in carrier aggregation. This requires timely and accurate measurement of the UE to maintain the quality of radio links.

In NR network, the SS/PBCH blocks (SSB) composed of synchronization signals (SS) and physical broadcast channels (PBCH) are introduced as cell (signal) measurement objects. The number of SSBs in a burst depends on an operating frequency. For example, when the operating frequency (fc) is less than 3 GHZ (FR1), the SSB is 4; when the operating frequency (fc) is between 3 GHZ (FR1) and 6 GHz (FR1), the SSB is 8; however, when the operating frequency (fc) is greater than 6 GHz (FR2), the SSB is 64.

The periodicity of a cell SSB can be configured as 5 ms, 10 ms, 20 ms, 40 ms, 80 ms, or 160 ms. The UE does not need to measure cell signals periodically since the SSB measurement periodicity can be adjusted according to channel conditions. This can help avoid unnecessary measurements and reducing energy consumption of the UE. The protocol introduces an SSB-based RRM measurement timing configuration window (known as the SMTC window), and through SMTC, the UE obtains the measurement periodicity and time for SSBs.

a) For a serving cell, serving cell configuration common (ServingCellConfigCommon) configures the SSB for the UE, initially configuring, for the UE, SSBs to be measured within one SSB burst, a SSB periodicity, and a transmit power through a bitmap.

From a time domain perspective, the RRC configuration for SSB-Measurement Timing Configuration (SSB-MTC) provides a precise timing when the UE should measure the SSB. The configuration specifies a measurement periodicity and offset, with the periodicity ranging from 5 subframes to 160 subframes, and a measurement time length in each periodicity ranging from 1 subframe to 5 subframes.

### b) SMTC (SSB-MTC) Measurement

The SMTC is configured for each frequency point, that is, if the frequency bands of two neighboring cells are the same, their SMTC configurations are the same. If a cell expects to modify the configuration of SMTC, the SMTC configuration for all other cells sharing the same frequency band will also change.

For matching different cells with different synchronization signal block periodicities, it is allowed to configure two sets of SMTC parameters for measurements of given cells during intra-frequency measurements in the connected mode, known as SMTC2. For example, in addition to the basic SMTC configuration, a set of more intensive measurement windows can be further configured for the serving cell and cells indicated in a specific cell list.

Frequency bands of SMTC2 and SMTC1 are still the same. If SMTC2 is configured, only a few cells are measured according to SMTC2, and the introduction of SMTC2 is driven by different cell coverage issues (such as small cells). Moreover, the periodicity of SMTC1 needs to be a multiple of the periodicity of SMTC2.

### c) Measurement Reporting

After the UE measures SSBs of the neighboring cell, it needs to send a measured result to the serving cell. The reporting configuration includes:
trigger reporting principle: periodic reporting or penalty rules of a series of events;
type of Reference Signal (RS): SSB or Channel State Information-Reference Signal (CSI-RS); and
form of measurement reporting: for example, the maximum number of reported cells and the number of beams.

The network may configure information reported by UE based on SSB as follows:
a measurement result of each SSB;
a measurement result of each cell; and
a measurement result based on SSB index.

### 6. Light SSB

To achieve power saving at the base station side, it is proposed to use a base station in power-saving mode to transmit only Dedicated Reference Signal (DRS) information. The DRS may be part of an existing SSB. That is, only the PSS and SSS may be sent, or only the PSS or SSS may be sent.

The following describes the SSB measurement method provided in the embodiments of this application through specific embodiments and application scenarios thereof with reference to the accompanying drawings.

UE performs measurement on surrounding cells to evaluate signal quality of the cells. In this process, the protocol stipulates that the UE needs to report information such as a measured cell ID and SSB index to a serving cell, so as to better perform mobility management. SSB index information is obtained from the PBCH and PBCH-DMRS. Therefore, in this case, for the power-saving base station (not including a PBCH) that sends light SSBs, how to obtain SSB index information of a cell needs to be resolved.

An embodiment of this application provides an SSB measurement method. The UE may monitor the first information sent by the power-saving base station to perform SSB measurement of the power-saving cell, and the first information includes at least one of the following: a first signal, where the first signal is formed by a second signal and a payload, the first signal explicitly carries SSB index information, and the second signal includes at least one of the following: a PSS or an SSS; a third signal, where the third signal is formed by a PSS and an SSS, and the third signal implicitly carries SSB index information; or a fourth signal, where the fourth signal includes at least one of the following: a PSS or an SSS, and the PSS and/or the SSS are in different frequency domain positions. In this solution, during monitoring on SSBs sent by the power-saving base station, the UE can detect the first information sent by the power-saving base station, where the first information explicitly or implicitly carries the SSB index information, that is, the UE can obtain the SSB index information from the detected first information to perform SSB measurement of the energy-saving cell. Therefore, this solution implements that the UE can obtain required SSB index information in an explicit or implicit manner in a case of light SSBs, thus facilitating SSB measurement and reporting by the UE.

An embodiment of this application provides an SSB measurement method, and FIG. 4 is a flowchart of an SSB measurement method according to an embodiment of this application. As shown in FIG. 4, the SSB measurement method provided in this embodiment of this application may include the following steps 201 and 202.

Step 201: UE monitors first information sent by a power-saving base station.

In this embodiment of this application, the first information may include at least one of the following:
a first signal, where the first signal is formed by a second signal and a payload, the first signal explicitly carries SSB index information, and the second signal includes at least one of the following: a PSS or an SSS;
a third signal, where the third signal is formed by a PSS and an SSS, and the third signal implicitly carries SSB index information; or
a fourth signal, where the fourth signal includes at least one of the following: a PSS or an SSS, and the PSS and/or the SSS are in different frequency domain positions.

In this embodiment of the application, the UE can detect the first information sent by the power-saving base station based on SSB information (that is, an SSB configuration) configured for the UE in a serving cell in which the UE is located.

It can be understood that in this embodiment of this application, the power-saving base station (the base station in the power-saving mode) sends SSB information (a light SSB), and during monitoring on the SSB information sent by the power-saving base station (for example, a neighboring power-saving base station), the UE may perform monitoring based on SSB information configured for the UE in the serving cell in which the UE is located, so as to explicitly, implicitly, or indirectly obtain SSB index information from the first information. That is, the SSB index information is explicitly carried by adding a payload to a symbol of the light SSB (second signal), and/or the SSB index information is implicitly carried by the third signal, and/or the SSB index information is indirectly obtained based on a frequency domain position of the PSS and/or SSS.

In some embodiments of this application, the SSB configuration may include at least one of the following: an SSB identifier, an SSB periodicity, an SSB time domain position, an SSB frequency domain position, an SMTC configuration, index configuration actually sent for SSB, and so on.

It should be noted that in this embodiment of this application, the SSB sent by the power-saving base station is a light SSB. In some embodiments of this application, the light SSB may include at least one of the following: PSS or SSS.

It should be noted that the PSS and/or SSS being in different frequency domain positions means that the PSS and/or SSS is in completely different or partially different frequency domain positions. The PSS being in different frequency domain positions means that the PSS can occupy at least one different frequency domain position. The SSS being in different frequency domain positions means that the SSS can occupy at least one different frequency domain position.

In some embodiments of this application, the payload may include a DMRS.

In some embodiments of this application, the payload is in a same symbol as the PSS and/or SSS.

In some embodiments of this application, the payload may be in two symbols, and the two symbols include a symbol in which the PSS is located and a symbol in which the SSS is located.

In some embodiments of this application, the SSB index information can be carried by the payload alone, and the payload does not include a DMRS.

In some embodiments of this application, the SSB index information may be carried by the DMRS alone.

In some embodiments of this application, the SSB index information may be carried by the payload, and the payload includes a DMRS.

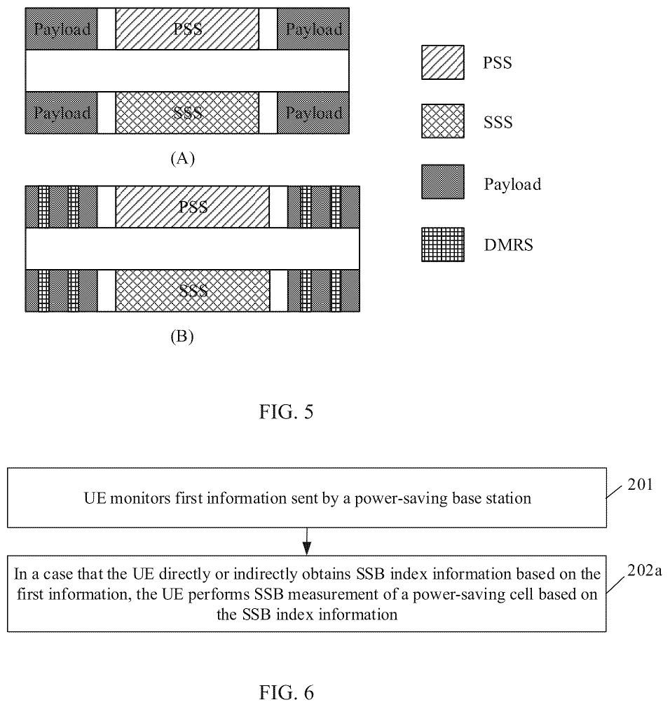

For example, as shown in FIG. 5, a payload is added to a symbol of a light SSB (a PSS and/or an SSS), and the payload may be single data or formed by data+DMRS. SSB index information may be carried by data alone, or carried by DMRS alone, or carried by data+DMRS.

In some embodiments of this application, the PSS and/or SSS being in different frequency domain positions: the power-saving base station configures the PSS and/or SSS in different frequency domain positions of a power-saving cell in advance, and the PSS and/or SSS in different frequency domain positions has different index information or index group information. A correspondence between frequency domain positions of the power-saving cell and the PSS and/or SSS is obtained by the UE through Radio Resource Control (RRC) signaling or downlink signal.

In some embodiments of this application, the RRC signaling or downlink signals are sent to the UE by the serving cell in which the UE is located.

It should be noted that the PSS and/or SSS being in different frequency domain positions has the following three schemes:

(1) The power-saving base station configures the PSS in different frequency domain positions of a power-saving cell in advance, and the PSS in different frequency domain positions has different index information or index group information.

(2) The power-saving base station configures the SSS in different frequency domain positions of a power-saving cell in advance, and the SSS in different frequency domain positions has different index information or index group information.

(3) The power-saving base station configures the PSS and SSS in different frequency domain positions of a power-saving cell in advance, and the PSS and SSS in different frequency domain positions have different index information or index group information.

In some embodiments of this application, the PSS and/or SSS being in different frequency domain positions may be in different synchronization rasters (sync raster).

It can be understood that the scheme here is to associate the SSB index information with the frequency domain position (such as a position of synchronization raster), so as to indirectly obtain the SSB index information.

For the base station, the power-saving base station may configure the PSS and/or SSS in different frequency domain positions in advance, and the PSS and/or SSS in different frequency domain positions have different indexes or index groups. The serving base station informs the UE of a correspondence between a frequency domain position of the power-saving cell and the PSS and/or SSS through RRC signaling or downlink signals.

For the UE, the UE performs blind detection in different frequency domain positions, and obtains SSB index information according to a correspondence between the frequency domain position of the power-saving base station and the PSS and/or SSS notified by the serving base station.

For example, the power-saving base station may configure an SSB index corresponding to a synchronization raster 100 to be 0; the power-saving base station may configure an SSB index corresponding to a synchronization raster 101 to be 1; the power-saving base station may configure an SSB index corresponding to a synchronization raster 102 to be 2; the power-saving base station may configure an SSB index corresponding to a synchronization raster 103 to be 3. The serving cell informs the UE of these correspondences, so that the UE can monitor SSBs of the power-saving base station on different synchronization rasters. If an SSB is detected on the synchronization raster 101, an index of the SSB is 1, and if an SSB is detected on the synchronization raster 102, an index of the SSB is 2.

It can be understood that the SSB index information can be explicitly carried by adding the payload to the symbol of the light SSB; and/or the SSB index information is implicitly determined in a manner in which sub-cell identifiers correspond to the SSB index information, and a plurality of sub-cell identifiers correspond to a same primary cell identifier; and/or the SSB index information is associated with a frequency domain position, so as to indirectly obtain the SSB index information.

Step 202: The UE performs SSB measurement of the power-saving cell based on the first information.

In this embodiment of this application, the power-saving cell is a serving cell of the power-saving base station.

In some embodiments of this application, the power-saving cell corresponds to at least one sub-cell identifier (sub-cell ID, such as a sub-PCI). A rule for implicitly carrying SSB index information by the third signal includes: each sub-cell identifier in part or all of the at least one sub-cell identifier corresponds to one piece of SSB index information.

All sub-cell identifiers in the at least one sub-cell identifier correspond to a same primary cell identifier (Pcell ID).

It should be noted that the power-saving cell being corresponding to at least one sub-cell identifier can be understood as: the power-saving cell includes at least one sub-cell, and an identifier of the at least one sub-cell is referred to as at least one sub-cell identifier, and each sub-cell corresponds to one sub-cell identifier.

In some embodiments of this application, the at least one sub-cell identifier is obtained through different PSSs and/or SSSs. That is, based on different N_{ID}⁽¹⁾ and N_{ID}⁽²⁾ different sub-cell identifiers are obtained.

In some embodiments of this application, the at least one sub-cell identifier is predefined by the protocol or preconfigured by the base station.

In some embodiments of this application, the at least one sub-cell identifier is configured by the serving cell in which the UE is located and notified to the UE.

In an implementation, the light SSB includes the PSS and the SSS. That is, the UE may obtain a sub-cell identifier by parsing the PSS and SSS.

The sub-cell identifier can be obtained by different PSS and/or SSS sequences. That is, different sub-cell identifiers are obtained based on N_{ID}⁽¹⁾ and N_{ID}⁽²⁾. All sub-cell identifiers in one cell correspond to a same primary cell identifier. In addition, different sub-cell identifiers in one cell correspond to different SSB indexes.

For example, at least one sub-cell identifier includes sub-cell identifiers 0, 1, 2, and 3; these sub-cell identifiers 0, 1, 2, and 3 correspond to SSB indexes 0, 1, 2, and 3 of cell 1; and a PCI of cell 1 is 100. Sub-cell identifiers 0, 1, 2, and 3 are in one-to-one correspondence to SSB indexes 0, 1, 2, and 3 of cell 1, that is, sub-cell identifier 0 corresponds to SSB index 0 of cell 1, sub-cell identifier 1 corresponds to SSB index 1 of cell 1, sub-cell identifier 2 corresponds to SSB index 2 of cell 1, and sub-cell identifier 3 corresponds to SSB index 3 of cell 1.

Further, for example, at least one sub-cell identifier includes sub-cell identifiers 4, 5, 6, and 7; these sub-cell identifiers 4, 5, 6, and 7 correspond to SSB index 0, 1, 2, and 3 of cell 2; and a PCI of cell 2 is 101. The sub-cell identifiers 4, 5, 6, and 7 are in one-to-one correspondence to SSB indexes 0, 1, 2, and 3 of cell 2. For details, refer to the description in the above examples, which is not repeated here.

Further, for example, at least one sub-cell identifier includes sub-cell identifiers 0, 1, 2, 3, and 4. The sub-cell identifiers 0, 1, 2, and 3 correspond to SSB 0, 1, 2, and 3 of cell 1 respectively. However, the sub-cell identifier 4 does not correspond to an SSB, but only to a primary cell identifier.

In some embodiments of this application, each SSB index information corresponds to one sub-cell identifier or one sub-cell identifier group. For example, sub-cell identifiers 0, 1, 2, and 3 correspond to SSB 0, 1, 2, and 3 respectively; or sub-cell identifiers 0 and 1 correspond to SSB 0, sub-cell identifiers 2 and 3 correspond to SSB 1, and sub-cell identifiers 4 and 5 correspond to SSB 2.

In some embodiments of this application, each sub-cell identifier in part or all of the sub-cell identifiers corresponds to one piece of SSB index information, including any one of the following:
the serving cell in which the UE is located directly indicates that each sub-cell identifier in part or all of the sub-cell identifiers corresponds to one piece of SSB index information; that is, the serving cell in which the UE is located directly indicates which sub-cell identifiers of the power-saving cell correspond to the SSB index information of the power-saving cell; or
the UE determines at least one beam index of the power-saving cell based on the at least one sub-cell identifier by using a rule configured by the serving cell in which the UE is located, and obtains based on the at least one beam index that each sub-cell identifier in part or all of the sub-cell identifiers corresponds to one piece of SSB index information.

In some embodiments of this application, the correspondence between each sub-cell identifier in part or all of the sub-cell identifiers and one piece of SSB index information is predefined by the protocol or preconfigured by the base station.

For example, the serving cell in which the UE is located directly indicates that the sub-cell identifiers 0, 1, 2, and 3 correspond to SSB indexes 0, 1, 2, and 3 of the cell 1 respectively, and sub-cell identifiers 4, 5, 6, and 7 correspond to SSB indexes 0, 1, 2 and 3 of cell 2 respectively.

In some embodiments of this application, the UE determines at least one beam index of the power-saving cell in a sub-cell ID mod N manner based on the number N of beams of the power-saving cell.

For example, it is assumed that cell 1 has 4 beams, and sub-cells of the cell are identified as 4, 5, 6, and 7. Then sub-cell ID mod N(4)=0, 1, 2, 3. Therefore, the sub-cell identifiers 4, 5, 6, and 7 correspond to the SSB indexes 0, 1, 2 and 3 respectively.

It can be understood that the UE can obtain, according to the foregoing rule, a corresponding cell PCI and SSB indexes after detecting sub-cell identifiers.

In some embodiments of this application, that all the sub-cell identifiers in the at least one sub-cell identifier correspond to a same primary cell identifier includes any one of the following:

The serving cell in which the UE is located directly indicates that all the sub-cell identifiers correspond to the same primary cell identifier; that is, the serving cell in which the UE is located directly indicates the sub-cell identifiers of the power-saving cell and the primary cell identifier of the power-saving cell;
one fixed-value sub-cell identifier in all the sub-cell identifiers is used as the primary cell identifier by default; or
a value determined based on all the sub-cell identifiers by using a rule configured by the serving cell in which the UE is located is used by the UE as the primary cell identifier.

In some embodiments of this application, the correspondence between all the sub-cell identifiers in the at least one sub-cell identifier and the same primary cell identifier is predefined by the protocol or preconfigured by the base station.

For example, the serving cell in which the UE is located directly indicates that the PCI of cell 1 corresponding to sub-cell identifiers 0, 1, 2, and 3 is 100; and the PCI of cell 1 corresponding to sub-cell identifiers 4, 5, 6, and 7 is 110.

In some embodiments of this application, the fixed-value sub-cell identifier may be the 1st or the last sub-cell identifier in all the sub-cell identifiers.

For example, if sub-cell identifiers of a specific cell are 4,5,6,7, a sub-cell identifier 4 is a cell PCI (that is, a primary cell identifier) by default.

In some embodiments of this application, the UE uses a value of sub-cell ID mod N=M as the primary cell identifier based on the number N of beams of the power-saving cell, where N and M are predefined values of the protocol.

For example, if sub-cell identifiers of a specific cell are 4,5,6,7, N=4, and M=0, sub-cell ID 4 is the cell PCI.

In some embodiments of this application, as shown in FIG. 4 and FIG. 6, the step 202 can be implemented by the following step 202a.

Step 202a: In a case that the UE directly or indirectly obtains SSB index information based on the first information, the UE performs SSB measurement of the power-saving cell based on the SSB index information.

In this embodiment of this application, the UE can monitor, based on the SSB index information, SSBs indicated by the SSB index information in the power-saving cell, and perform measurement on these SSBs to obtain and report a measurement result to the serving cell in which the UE is located, so as to facilitate the serving cell to perform related operations based on the measurement result, for example, triggering the UE to perform cell handover and signal interference processing.

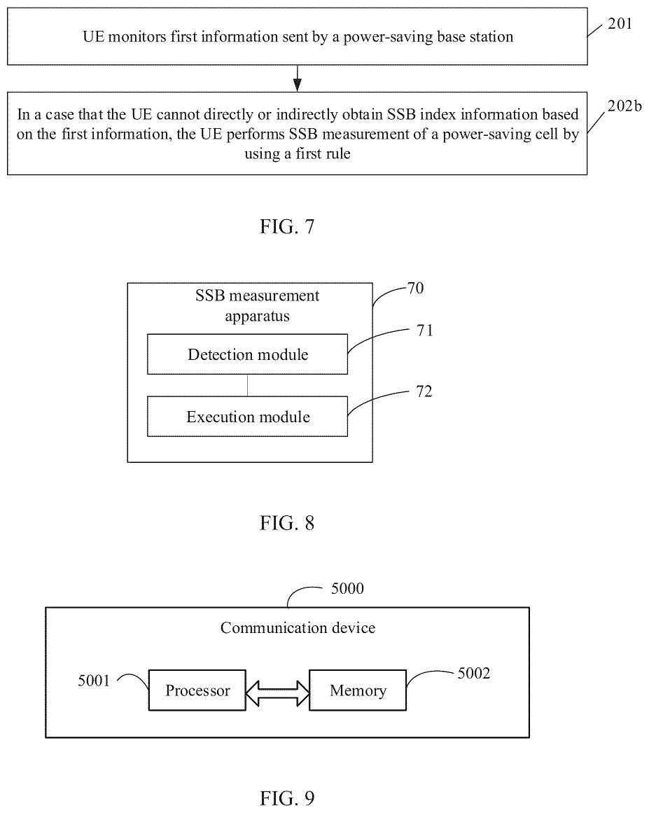

In some embodiments of this application, as shown in FIG. 7 in combination with FIG. 4, the step 202 can be implemented by performing the following step 202b.

Step 202b: In a case that the UE cannot directly or indirectly obtain the SSB index information based on the first information, the UE performs SSB measurement of the power-saving cell by using a first rule.

In this embodiment of the application, the first rule is that the UE measures an RSRP of the SSB at at least one moment and reports a measurement result.

In some embodiments of this application, “the UE performs SSB measurement of the power-saving cell by using the first rule” in the foregoing step 202b can be implemented by performing the following step 202b1 or step 202b2.

Step 202b1: The UE measures an RSRP of the SSB of the power-saving cell at a plurality of moments to obtain a first measurement result.

In this embodiment of this application, the first measurement result is obtained based on a largest RSRP in RSRPs obtained during each measurement.

In some embodiments of this application, the UE may measure an RSRP of the light SSB at a plurality of moments, and uses the largest RSRP measured each time for processing. The processing may be as follows: summing and averaging a plurality of largest RSRPs to obtain the first measurement result; or signal stability of the plurality of largest RSRPs is evaluated, and an RSRP with the best signal stability is used as the first measurement result.

Step 202b2: The UE measures an RSRP of the SSB of the power-saving cell at a first moment, and performs SSB measurement of the power-saving cell at a position in an SSB periodicity corresponding to an SSB with the largest RSRP.

It can be understood that the UE can measure the RSRP of the light SSB at the first moment, find the SSB with the largest RSRP, and then performs SSB monitoring at the position corresponding to the SSB with the largest RSRP.

For example, the UE receives 4 light SSBs at the first moment. An RSRP of the 2nd SSB (SSB 2) measured is the best. If an SSB periodicity is 20 ms, the UE continues to measure the RSRP of SSB 2 at a position 20 ms after SSB 2, perform processing at layer 3 based on multiple measurement results, and report a processing result to the serving cell in which the UE is located.

In this embodiment of this application, when the UE cannot directly or indirectly obtain the SSB index information, the UE can measure the RSRP of the SSB at a plurality of moments or at the first moment by using the first rule, and report the measurement result to the serving cell in which the UE is located, so that the serving cell can perform related operations based on the measurement result.

An embodiment of this application provides an SSB measurement method. The UE may monitor the first information sent by the power-saving base station to perform SSB measurement of the power-saving cell, and the first information includes at least one of the following: a first signal, where the first signal is formed by a second signal and a payload, the first signal explicitly carries SSB index information, and the second signal includes at least one of the following: a PSS or an SSS; a third signal, where the third signal is formed by a PSS and an SSS, and the third signal implicitly carries SSB index information; or a fourth signal, where the fourth signal includes at least one of the following: a PSS or an SSS, and the PSS and/or the SSS are in different frequency domain positions. In this solution, during monitoring on SSB information sent by the power-saving base station, the UE can detect the first information sent by the power-saving base station, where the first information explicitly or implicitly carries the SSB index information, that is, the UE can obtain the SSB index information from the detected first information to perform SSB measurement of the power-saving cell. Therefore, this solution implements that the UE can obtain required SSB index information in an explicit or implicit manner in a case of light SSBs, thus facilitating SSB measurement and reporting by the UE.

The execution subject of the SSB measurement method provided in the embodiments of this application may be an SSB measurement apparatus. In the embodiments of this application, the SSB measurement apparatus provided in the embodiments of this application is described by using the SSB measurement method being executed by the UE as an example.

FIG. 8 is a schematic structural diagram of an SSB measurement apparatus involved in the embodiments of this application, and the SSB measurement apparatus is applied to UE. As shown in FIG. 8, the SSB measurement apparatus 70 may include a detection module 71 and an execution module 72.

The detection module 71 is configured to monitor first information sent by a power-saving base station; and the execution module 72 is configured to perform SSB measurement of a power-saving cell based on the first information detected by the detection module 71, where the power-saving cell is a serving cell of the power-saving base station. The first information includes at least one of the following:
a first signal, where the first signal is formed by a second signal and a payload, the first signal explicitly carries SSB index information, and the second signal includes at least one of the following: a PSS or an SSS;
a third signal, where the third signal is formed by a PSS and an SSS, and the third signal implicitly carries SSB index information; or
a fourth signal, where the fourth signal includes at least one of the following: a PSS or an SSS, and the PSS and/or the SSS are in different frequency domain positions.

This embodiment of this application provides an SSB measurement apparatus. During monitoring on the SSB information sent by the power-saving base station, the SSB measurement apparatus can perform monitoring based on the first information configured by the serving cell, where the first information explicitly or implicitly carries the SSB index information, that is, the UE can obtain the SSB index information from the detected first information to perform SSB measurement of the power-saving cell. Therefore, this solution implements that the SSB measurement apparatus can obtain required SSB index information in an explicit or implicit manner in a case of light SSBs, thus facilitating SSB measurement and reporting by the SSB measurement apparatus.

In an implementation, the payload includes a DMRS.

In an implementation, the payload is in a same symbol as a PSS and/or an SSS; or the payload is in two symbols, and the two symbols include a symbol in which the PSS is located and a symbol in which the SSS is located.

In an implementation, the SSB index information is carried by the payload alone, and the payload does not include a DMRS; or the SSB index information is carried by a DMRS alone; or the SSB index information is carried by the payload, and the payload includes a DMRS.

In an implementation, the power-saving cell corresponds to at least one sub-cell identifier. A rule for implicitly carrying SSB index information by the third signal includes: each sub-cell identifier in part or all of the at least one sub-cell identifier corresponds to one piece of SSB index information; where all sub-cell identifiers in the at least one sub-cell identifier correspond to a same primary cell identifier.

In an implementation, the at least one sub-cell identifier is obtained through different PSSs and/or SSSs.

In an implementation, that each sub-cell identifier in part or all of the sub-cell identifiers corresponds to one piece of SSB index information includes any one of the following:
a serving cell in which the UE is located directly indicates that each sub-cell identifier in part or all of the sub-cell identifiers corresponds to one piece of SSB index information; or
the UE determines at least one beam index of the power-saving cell based on the at least one sub-cell identifier by using a rule configured by the serving cell in which the UE is located, and obtains based on the at least one beam index that each sub-cell identifier in part or all of the sub-cell identifiers corresponds to one piece of SSB index information.

In an implementation, that all sub-cell identifiers correspond to a same primary cell identifier includes any one of the following:
a serving cell in which the UE is located directly indicates that all the sub-cell identifiers correspond to a same primary cell identifier;
one fixed-value sub-cell identifier in all the sub-cell identifiers is used as the primary cell identifier by default; or
a value determined based on all the sub-cell identifiers by using a rule configured by the serving cell in which the UE is located is used by the UE as the primary cell identifier.

In an implementation, that the PSS and/or the SSS are in different frequency domain positions means: the power-saving base station configures the PSS and/or SSS in different frequency domain positions of the power-saving cell in advance, and the PSS and/or SSS in different frequency domain positions have different index information or index group information; where a correspondence between frequency domain positions of the power-saving cell and the PSS and/or SSS is obtained by the UE through RRC signaling or downlink signals.

In an implementation, the execution module is configured to:
in a case that the UE directly or indirectly obtains SSB index information based on the first information, perform SSB measurement of the power-saving cell based on the SSB index information; or
in a case that the UE is unable to directly or indirectly obtain the SSB index information based on the first information, perform SSB measurement of the power-saving cell by using a first rule, where the first rule is that the UE measures an RSRP of an SSB at at least one moment and reports a measurement result.

In an implementation, the execution module is configured to perform any one of the following:
measuring an RSRP of the SSB of the power-saving cell at a plurality of moments to obtain a first measurement result, where the first measurement result is obtained based on a largest RSRP in RSRPs obtained during each measurement; or
measuring an RSRP of the SSB of the power-saving cell at a first moment, and performing SSB measurement of the power-saving cell at a position in an SSB periodicity corresponding to an SSB with a largest RSRP.

The SSB measurement apparatus provided in this embodiment of this application can implement the processes implemented by the UE in the foregoing method embodiment, with the same technical effects achieved. To avoid repetition, details are not described herein again.

The SSB measurement apparatus in this embodiment of this application may be UE, such as UE with an operating system, or a component in the UE, such as an integrated circuit or a chip. The UE may be a terminal or other devices than the terminal. For example, the UE may include, but is not limited to, the types of the UE 11 listed above, and other devices may be a server, a Network Attached Storage (NAS), and the like. This is not limited in the embodiments of this application.

As shown in FIG. 9, an embodiment of this application further provides a communication device 5000, including a processor 5001 and a memory 5002. A program or instructions capable of running on the processor 5001 are stored in the memory 5002. For example, when the communication device 5000 is UE and when the program or the instructions are executed by the processor 5001, the steps of the foregoing embodiments of the method on the UE side are implemented, with the same technical effects achieved. To avoid repetition, details are not described herein again.

An embodiment of this application further provides UE, which includes a processor and a communication interface, where the processor is configured to monitor first information sent by a power-saving base station; and perform SSB measurement of a power-saving cell based on the first information, where the power-saving cell is a serving cell of the power-saving base station. The first information includes at least one of the following: a first signal, where the first signal is formed by a second signal and a payload, the first signal explicitly carries SSB index information, and the second signal includes at least one of the following: a PSS or an SSS; a third signal, where the third signal is formed by a PSS and an SSS, and the third signal implicitly carries SSB index information; and a fourth signal, where the fourth signal includes at least one of the following: a PSS or an SSS, and the PSS and/or the SSS are in different frequency domain positions. The UE embodiment corresponds to the foregoing UE side method embodiment, and the implementation processes and implementations of the foregoing method embodiments can be applied to the UE embodiments, with the same technical effects achieved.

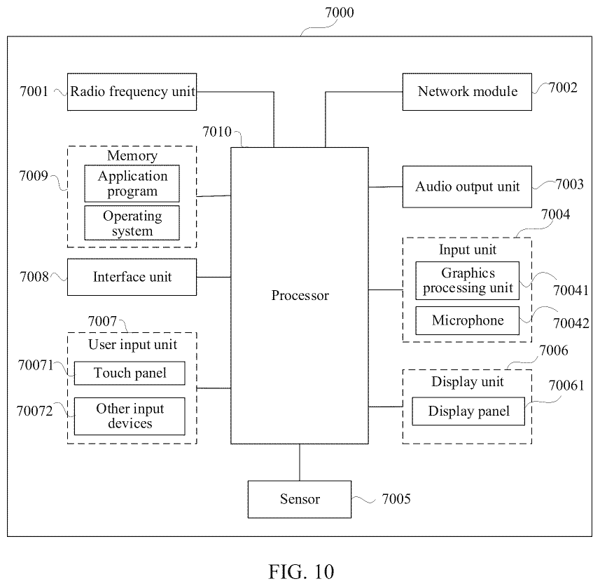

FIG. 10 is a schematic diagram of a hardware structure of UE implementing an embodiment of this application.

The UE 7000 includes but is not limited to at least part of components such as a radio frequency unit 7001, a network module 7002, an audio output unit 7003, an input unit 7004, a sensor 7005, a display unit 7006, a user input unit 7007, an interface unit 7008, a memory 7009, and a processor 7010.

A person skilled in the art may understand that the UE 7000 may further include a power supply (such as a battery) for supplying power to the components. The power supply may be logically connected to the processor 7010 through a power management system. In this way, functions such as charge management, discharge management, and power consumption management are implemented by using the power management system. The structure of the UE shown in FIG. 10 does not constitute a limitation on the UE. The UE may include more or fewer components than those shown in the figure, or some components are combined, or component arrangements are different. Details are not described herein again.

It can be understood that in this embodiment of this application, the input unit 7004 may include a Graphics Processing Unit (GPU) 70041 and a microphone 70042. The graphics processing unit 70041 processes image data of a still picture or video obtained by an image capture apparatus (such as a camera) in a video capture mode or an image capture mode. The display unit 7006 may include a display panel 70061, and the display panel 70061 may be configured in a form of a liquid crystal display, an organic light-emitting diode, and the like. The user input unit 7007 includes at least one of a touch panel 70071 or other input devices 70072. The touch panel 70071 is also referred to as a touchscreen. The touch panel 70071 may include two parts: a touch detection apparatus and a touch controller. The other input devices 70072 may include but are not limited to a physical keyboard, a function key (such as a volume control key or a power on/off key), a trackball, a mouse, a joystick, and the like. Details are not described herein.

In this embodiment of this application, after receiving downlink data from a network-side device, the radio frequency unit 7001 sends the downlink data to the processor 7010 for processing; and the radio frequency unit 7001 also sends uplink data to the network-side device. Generally, the radio frequency unit 7001 includes, but is not limited to, an antenna, an amplifier, a transceiver, a coupler, a low noise amplifier, a duplexer, and the like.

The memory 7009 may be configured to store software programs or instructions and various data. The memory 7009 may mainly include a first storage area for storing programs or instructions and a second storage area for storing data, where the first storage area may store an operating system, an application program or instructions required by at least one function (for example, an audio playing function and an image playing function), and the like. In addition, the memory 7009 may be a volatile memory or a non-volatile memory, or the memory 7009 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 7009 described in this embodiment this application includes but is not limited to these and any other suitable types of memories.

The processor 7010 may include one or more processing units. In some embodiments, the processor 7010 integrates an application processor and a modem processor. The application processor mainly processes operations related to an operating system, a user interface, an application program, and the like. The modem processor mainly processes wireless communication signals, for example, a baseband processor. It should be understood that, the modem processor may not be integrated into the processor 7010.

The processor 7010 is configured to monitor first information sent by a power-saving base station; and perform SSB measurement of a power-saving cell based on the first information, where the power-saving cell is a serving cell of the power-saving base station. The first information includes at least one of the following:
a first signal, where the first signal is formed by a second signal and a payload, the first signal explicitly carries SSB index information, and the second signal includes at least one of the following: a PSS or an SSS;
a third signal, where the third signal is formed by a PSS and an SSS, and the third signal implicitly carries SSB index information; or
a fourth signal, where the fourth signal includes at least one of the following: a PSS or an SSS, and the PSS and/or the SSS are in different frequency domain positions.

The embodiment of the application provides a UE. When detecting SSB information sent by a power-saving base station, the UE can detect the first information sent by the power-saving base station, which explicitly or implicitly carries SSB index information, that is, the UE can obtain SSB index information from the detected first information to perform SSB measurement in a power-saving cell. Therefore, this scheme realizes that the UE can obtain the required SSB index information in an explicit or implicit way under light SSB, thus facilitating the SSB measurement and reporting by the UE.

The UE provided in this embodiment of this application can implement the processes implemented by the UE in the foregoing method embodiment, with the same technical effects achieved. To avoid repetition, details are not described herein again.

An embodiment of this application further provides a readable storage medium, where the readable storage medium stores a program or instructions, and when the program or the instructions are executed by a processor, the processes of the foregoing embodiments of the SSB measurement method are implemented, with the same technical effects achieved. To avoid repetition, details are not described herein again.

The processor is the processor in the communication device in the foregoing embodiment. The readable storage medium includes a computer-readable storage medium, for example, a computer read only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement each process of the foregoing method embodiment, with the same technical effect achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and when being executed by at least one processor, the computer program/program product is configured to implement the processes of the foregoing embodiments of the method, with the same technical effects achieved. To avoid repetition, details are not repeated herein.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. In some embodiments, the method in the foregoing embodiment may also be implemented by hardware. Based on such an understanding, the technical solutions of this application essentially or the part contributing to the prior art may be implemented in a form of a software product. The software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A method for synchronization signal block (SSB) measurement, comprising:
monitoring, by user equipment (UE), first information sent by a power-saving base station; and
performing, by the UE, SSB measurement of a power-saving cell based on the first information, wherein the power-saving cell is a serving cell of the power-saving base station,
wherein the first information comprises at least one of the following:
a first signal, wherein the first signal is formed by a second signal and a payload, the first signal explicitly carries SSB index information, and the second signal comprises at least one of the following: a primary synchronization signal (PSS) or a secondary synchronization signal (SSS);
a third signal, wherein the third signal is formed by a PSS and an SSS, and the third signal implicitly carries SSB index information; or
a fourth signal, wherein the fourth signal comprises at least one of the following:
a PSS or an SSS, and the PSS and the SSS are in different frequency domain positions.

2. The method according to claim 1, wherein a demodulation reference signal (DMRS) is comprised in the payload.

3. The method according to claim 1, wherein the payload is in a same symbol as the PSS or the SSS; or
the payload is in two symbols, wherein the two symbols comprise a symbol in which the PSS is located and a symbol in which the SSS is located.

4. The method according to claim 2, wherein the SSB index information is carried by the payload alone, and the payload does not comprise the DMRS;
the SSB index information is carried by the DMRS alone; or
the SSB index information is carried by the payload, and the payload comprises the DMRS.

5. The method according to claim 1, wherein the power-saving cell corresponds to at least one sub-cell identifier; and
a rule for implicitly carrying SSB index information by the third signal comprises: each sub-cell identifier in part or all of the at least one sub-cell identifier corresponds to one piece of SSB index information,
wherein all sub-cell identifiers in the at least one sub-cell identifier correspond to a same primary cell identifier.

6. The method according to claim 5, wherein the at least one sub-cell identifier is obtained from different PSSs or SSSs.

7. The method according to claim 5, wherein that each sub-cell identifier in part or all of the sub-cell identifiers corresponds to one piece of SSB index information comprises any one of the following:
a serving cell in which the UE is located directly indicates that each sub-cell identifier in part or all of the sub-cell identifiers corresponds to one piece of SSB index information; or
the UE determines at least one beam index of the power-saving cell based on the at least one sub-cell identifier by using a rule configured by the serving cell in which the UE is located, and obtains based on the at least one beam index that each sub-cell identifier in part or all of the sub-cell identifiers corresponds to one piece of SSB index information.

8. The method according to claim 5, wherein that all sub-cell identifiers correspond to a same primary cell identifier comprises any one of the following:
a serving cell in which the UE is located directly indicates that all the sub-cell identifiers correspond to a same primary cell identifier;
one fixed-value sub-cell identifier in all the sub-cell identifiers is used as the primary cell identifier by default; or
a value determined based on all the sub-cell identifiers by using a rule configured by the serving cell in which the UE is located is used by the UE as the primary cell identifier.

9. The method according to claim 1, wherein that the PSS and the SSS are in different frequency domain positions comprises: the power-saving base station configures the PSS and SSS in different frequency domain positions of the power-saving cell in advance, and the PSS and SSS in different frequency domain positions have different index information or index group information,
wherein a correspondence between frequency domain positions of the power-saving cell and the PSS and SSS is obtained by the UE through radio resource control RRC signaling or downlink signals.

10. The method according to claim 1, wherein the performing, by the UE, SSB measurement of a power-saving cell based on the first information comprises:
when the UE directly or indirectly obtains SSB index information based on the first information, the UE performs SSB measurement of the power-saving cell based on the SSB index information; or
when the UE is unable to directly or indirectly obtain the SSB index information based on the first information, the UE performs SSB measurement of the power-saving cell by using a first rule, wherein the first rule is that the UE measures a reference signal received power (RSRP) of an SSB at at least one moment and reports a measurement result.

11. The method according to claim 10, wherein that the UE performs SSB measurement of the power-saving cell by using a first rule comprises any one of the following:
the UE measures the RSRP of the SSB of the power-saving cell at a plurality of moments to obtain a first measurement result, wherein the first measurement result is obtained based on a largest RSRP in RSRPs obtained during each measurement; and
the UE measures the RSRP of the SSB of the power-saving cell at a first moment, and performs SSB measurement of the power-saving cell at a position in an SSB periodicity corresponding to an SSB with a largest RSRP.

12. User equipment (UE), comprising a processor and a memory storing a program or an instruction that is capable of running on the processor, wherein the program or the instruction, when executed by the processor, causes the UE to perform:
monitoring first information sent by a power-saving base station; and
performing synchronization signal block (SSB) measurement of a power-saving cell based on the first information, wherein the power-saving cell is a serving cell of the power-saving base station,
wherein the first information comprises at least one of the following:
a first signal, wherein the first signal is formed by a second signal and a payload, the first signal explicitly carries SSB index information, and the second signal comprises at least one of the following: a primary synchronization signal (PSS) or a secondary synchronization signal (SSS);
a third signal, wherein the third signal is formed by a PSS and an SSS, and the third signal implicitly carries SSB index information; or
a fourth signal, wherein the fourth signal comprises at least one of the following:
a PSS or an SSS, and the PSS and the SSS are in different frequency domain positions.

13. The UE according to claim 12, wherein a demodulation reference signal (DMRS) is comprised in the payload.

14. The UE according to claim 12, wherein the payload is in a same symbol as the PSS or the SSS; or
the payload is in two symbols, wherein the two symbols comprise a symbol in which the PSS is located and a symbol in which the SSS is located.

15. The UE according to claim 13, wherein the SSB index information is carried by the payload alone, and the payload does not comprise the DMRS;
the SSB index information is carried by the DMRS alone; or
the SSB index information is carried by the payload, and the payload comprises the DMRS.

16. The UE according to claim 12, wherein the power-saving cell corresponds to at least one sub-cell identifier; and
a rule for implicitly carrying SSB index information by the third signal comprises: each sub-cell identifier in part or all of the at least one sub-cell identifier corresponds to one piece of SSB index information,
wherein all sub-cell identifiers in the at least one sub-cell identifier correspond to a same primary cell identifier.

17. The UE according to claim 16, wherein the at least one sub-cell identifier is obtained from different PSSs or SSSs.

18. The UE according to claim 16, wherein that each sub-cell identifier in part or all of the sub-cell identifiers corresponds to one piece of SSB index information comprises any one of the following:
a serving cell in which the UE is located directly indicates that each sub-cell identifier in part or all of the sub-cell identifiers corresponds to one piece of SSB index information; or
the UE determines at least one beam index of the power-saving cell based on the at least one sub-cell identifier by using a rule configured by the serving cell in which the UE is located, and obtains based on the at least one beam index that each sub-cell identifier in part or all of the sub-cell identifiers corresponds to one piece of SSB index information.

19. The UE according to claim 16, wherein that all sub-cell identifiers correspond to a same primary cell identifier comprises any one of the following:
a serving cell in which the UE is located directly indicates that all the sub-cell identifiers correspond to a same primary cell identifier;
one fixed-value sub-cell identifier in all the sub-cell identifiers is used as the primary cell identifier by default; or
a value determined based on all the sub-cell identifiers by using a rule configured by the serving cell in which the UE is located is used by the UE as the primary cell identifier.

20. A non-transitory computer-readable storage medium storing a program or an instruction, wherein the program or the instruction, when executed by a processor, causes the processor to perform:
monitoring, by user equipment (UE), first information sent by a power-saving base station; and
performing, by the UE, SSB measurement of a power-saving cell based on the first information, wherein the power-saving cell is a serving cell of the power-saving base station,
wherein the first information comprises at least one of the following:
a first signal, wherein the first signal is formed by a second signal and a payload, the first signal explicitly carries SSB index information, and the second signal comprises at least one of the following: a primary synchronization signal (PSS) or a secondary synchronization signal (SSS);
a third signal, wherein the third signal is formed by a PSS and an SSS, and the third signal implicitly carries SSB index information; or
a fourth signal, wherein the fourth signal comprises at least one of the following:
a PSS or an SSS, and the PSS and the SSS are in different frequency domain positions.
